(19) United States
(12) Patent Application Publication
(10) Pub. No.: US 2009/0169792 A1
(43) Pub. Date: Jul. 2, 2009

(54) DISPLAY WINDOW HAVING A RECESS AND METHOD FOR PRODUCING THE SAME

(75) Inventors: Byung-Hoon Ryou, Seoul (KR); Won-Mo Sung, Gyeonggi-do (KR); Min-Su Kim, Gyeonggi-do (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: E.M. W. Antnna Co.,, Seoul (KR)

(21) Appl. No.: 11/912,835

(22) PCT Filed: May 2, 2006
(86) PCT No.: PCT/KR06/01639

§ 371 Date: Nov. 17, 2008

(30) Foreign Application Priority Data
Apr. 29, 2005 (KR) 10 2005 0035818
Sep. 6, 2005 (KR) 20 2005 0025697

(51) Int. Cl. B32B 3/00; B26D 3/00

(52) U.S. Cl. 428/38; 83/49

(57) ABSTRACT

Disclosed are a display window in which a recess having a smooth surface is formed and method of producing the same. A recess having a smooth surface, which may look visually convex, is formed in the window of the present invention. Therefore, an external appearance of the window is beautiful. Furthermore, the recess and the through-hole are formed at a location in which the speaker is installed. Accordingly, a mobile phone assembly process can be simplified and become efficient. Meanwhile, in the method of producing the window according to the present invention, the recess is formed to have a circular bite. It is therefore possible to obtain a recess having a smooth surface. Furthermore, since the recess is processed during the plate process, a window having a high hardness, a good transparency, and a variety of shapes can be fabricated.

### TECHNICAL FIELD

The present invention relates generally to a display window and method of producing the same, and more particularly, to a display window for use in a wireless communication terminal display, in which a recess is formed through a three-dimensional process, and method of producing the same.

### BACKGROUND ART

Recently, with a rapid development of wireless communication, portable wireless communication terminals, such as mobile phones and PDA, have been widely used. In general, the wireless communication terminal includes a display unit for displaying contents input by a user, an operating state of the terminal, etc.

The construe don of a conventional folder-type mobile phone will be described below. FIG. 10 is a perspective view of a conventional mobile phone. Referring to FIG. 10, the mobile phone mainly includes a main body 60 having a keypad and a microphone, and a flip 62 in which a speaker for audio outputs, a display for visual outputs, and so on are installed. A through-hole and a concavo-convex part 70 are formed in a portion in which the speaker is installed. They allow the output of the speaker to smoothly transferred to a user and a user to easily identify the location of the speaker. A LCD is generally used as the display, and a window 64 for protecting LCD is formed on the LCD.

The window 64 includes a transparent portion 66 allowing a user to view displayed contents of the LCD, and a peripheral portion 68 surrounding the transparent portion 66. The transparent portion 66 must have the LCD be seen through it without distorting displayed contents. Thus, it is required that the transparent portion 66 be made of a material with high transmissivity, and special glass or acrylic material is generally used for the transparent portion 66. Meanwhile, the peripheral portion 68 must be opaque in order for a user not to view the inside of the flip 62 unlike the transparent portion. In general, the peripheral portion 68 is coated with an opaque or reflective film, or is fabricated by a method, such as insert molding process, where the peripheral portion 68 is molded with a film included in if.

Conventional methods of fabricating the window 64 include an injection molding method and a plate processing method.

The injection molding method employs in-mold injection or insert injection. When the insert injection method is used, a film on which predetermined pattern has been printed is inserted into an injection mold and injection molding of material, such as acrylic, is performed in order to form an opaque peripheral portion 68. When the in-mold injection method is used, a transfer film on which a predetermined pattern has been printed is inserted into an injection mold and injection is perforated, so that transfer of a desired pattern and injection are carried out simultaneously.

However, in the method employing injection molding, especially, the method employing insert injection, the film is left within an injection matter. Therefore, the film exists not only in the peripheral portion 68, but also in the transparent portion 66 of the window 64. Accordingly, a problem arises because the transparency of the transparent portion 66 is degraded due to the film. Furthermore, the hardness of a material used in the injection molding is lower than 3h in pencil hardness. Therefore, there are problems in that scratch is likely to occur and the visibility of the LCD through the transparent portion 66 is degraded.

A conventional method of fabricating the window 64 using a plate process will be described below. A plate made of acrylic, etc. is first prepared. To form the peripheral portion 68, opaque paints are printed or deposited in a predetermined shape. The plate is cut (routed) in the shape of the window 64, completing the window 64. In the case of the plate process, the hardness of the plate is higher than 5h in pencil hardness. Therefore, the process is advantageous in that result window is insensitive to scratch compared to the window by injection molding. Furthermore, since deposition or printing is used in order to form, the peripheral portion 68, other materials than the plate itself are not added, to the transparent portion 66 resulting no degrading in the transparency.

In the conventional plate processing method, however, after painting or depositing only to perform, two-dimensional cutting is possible. This enables only a plane shape to be formed or processed. Therefore, the conventional plate processing method is problematic in that it is low in the degree of freedom in designing compared with the method employing injection molding, which allows a three-dimensional curve to be formed.

Furthermore, since the three-dimensional process is impossible in the plate process as described above, it is impossible to form the through-hole and the concavo-convex part 70, which are formed in the speaker portion, on the window in the flip 62. As a result, an additional component having the through-hole and the concavo-convex part 70 has to be made separately and assembled with the flip 62. This makes it complicated the assembly process of the mobile phone.

### DISCLOSURE OF INVENTION

### Technical Problem

Accordingly, the present invention has been made in view of the above problems occurring in the prior art, and it is an object of the present invention to provide a method of producing a window, which can produce a window with a high hardness while allowing for a three-dimensional process.

Another object of the present invention is to provide a method of producing a window, which can produce a window having an elegant appearance by forming a recess having a smooth surface.

Still another object of the present invention is to provide a method of producing a window in which a recess and a through-hole are formed, thus making it unnecessary to couple an additional component to a speaker installation portion.

Yet another object, of the present invention is to provide a window having an elegant appearance by including a recess having a smooth surface.

A further object, of the present invention is to provide a window in which a recess and a through-hole are formed at a location in which a speaker is installed.

### Technical Solution

To achieve the above objects, according to an aspect of the present invention, there is provided a method of producing a window for protecting a display of a mobile phone, the method including the steps of; preparing a transparent plate; forming a recess at a predetermined position of the plate through a cutting process; and cutting the plate in the shape of the window.

The cutting process in the forming may be performed using a bite with a circular bite tip.

Furthermore, the cutting process in the forming may be performed using a bite with a bite tip made of natural diamond.

To achieve the above objects, according to another aspect of the present invention, there is provided a method of producing a window for protecting a display of a mobile phone, the method including the steps of: preparing a transparent plate; forming a recess at a predetermined position of the plate through a cutting process; polishing the surface of the recess; and cutting the plate in the shape of the window.

The cutting process in the forming may be performed using a bite with a circular bite tip.

To achieve the above objects, according to yet another aspect of the present invention, there is provided a method of producing a window for protecting a display of a mobile phone, the method including steps of: preparing a transparent plate; forming initially a recess at a predetermined position of the plate through a first cutting process: forming finally the recess at a predetermined position of the plate through a second cutting process; polishing the surface of the recess; and cutting the plate in the shape of the window.

The second cutting process may be performed using a bite with a circular bite tip.

The second cutting process may be performed using a bite with a bite tip made of natural diamond.

In the second cutting process, a bite may rotates and/or be conveyed in an opposite direction to a direction in which a bite rotates and/or conveyed in the first cutting process.

To achieve the above objects, according to further another aspect of the present invention, there is provided a window for protecting a display of a mobile phone, comprising: a transparent portion for allowing a user to view displayed content of the display; and a peripheral portion for prohibiting the user from, viewing portions other than the displayed content, wherein a recess having a smooth surface is formed in the peripheral portion.

The recess may be formed at a location corresponding to a location at which a speaker of the mobile phone is installed, and a through-hole is formed in the recess.

### ADVANTAGEOUS EFFECTS

According to the present invention, in fabricating a window through a plate process, a recess is formed and a three-dimensional window process is made possible accordingly. Therefore, the degree of freedom in designing can be increased while maintaining the hardness of the window high.

Furthermore, according to the present invention, a recess having a smooth surface is formed. It is therefore possible to fabricate a window with an elegant appearance.

In addition, according to the present invention, since a through-hole is formed in the recess, it is not necessary to couple an additional component to a location in which a speaker is formed. This allows a mobile phone to be fabricated through only the coupling of the window. Therefore, the efficiency of the mobile phone producing process can be increased and the cost can be saved.

### BRIEF DESCRIPTION OF THE DRAWINGS

FIG. 1 is a top view of a window according to an embodiment of the present invention;

FIG. 2 is across-sectional view of the window taken along line A-A′ in FIG. 1;

FIG. 3 is a top view of a window according to another embodiment of the present invention;

FIG. 4 is a cross-sectional view of the window taken along line B-B′ in FIG. 3;

FIG. 5 is a flowchart illustrating a method of producing a window according to a first embodiment of the present invention;

FIG. 6 shows a bite used in the window producing method according to the embodiment of FIG. 5;

FIG. 7 shows a bite tip of the bite shown in FIG. 6;

FIG. 8 is a flowchart illustrating a method of producing a window according to a second embodiment of the present invention;

FIG. 9 is a flowchart illustrating a method of producing a window according to a third embodiment of the present invention; and

FIG. 10 is a perspective view of a conventional mobile phone.

### MODE FOR THE INVENTION

The present invention will now be described in detail in connection with specific embodiments with reference to the accompanying drawings. The present invention will be described below in connection with detailed shape, material and process steps of a window, a recess, a bite, etc. However, it is only illustrative and those skilled in the art will modify or change the present invention within the spirit of the present invention.

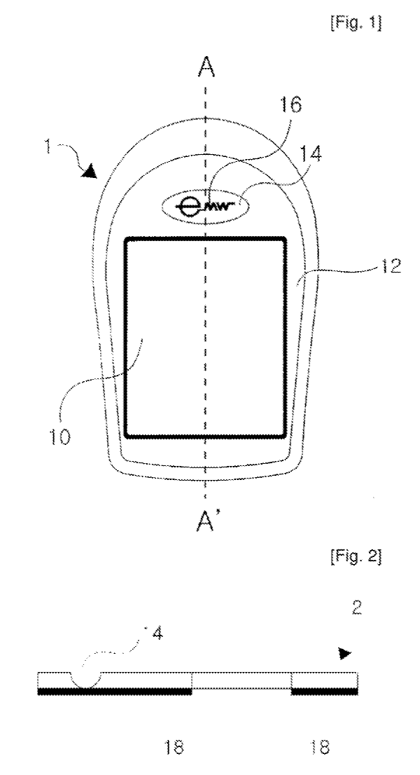

FIG. 1 is a top view of a window according to an embodiment of the present invention. The window 1 of the present embodiment includes a transparent portion 10 and a peripheral portion 12, and a recess 14 is formed in the peripheral portion 12. The window 1 is generally fabricated by cutting a plate in a predetermined shape. The plate may be made of a transparent material with a high hardness, such as special glass or acrylic. By forming the recess 14 in the plate, an external appearance of the window 1 can become elegant, and thus the external appearance of the mobile phone can become beautiful.

FIG. 2 is a cross-sectional view of the window taken along line A-A′ in FIG. 1. Paints 18 are printed, or deposited on locations corresponding to the peripheral portion 12 of the window 1, thus making the peripheral portion 12 opaque, while the paints 18 are not printed or deposited on locations corresponding to the transparent portion 10. Therefore, other materials than the material of the window 1 itself am not added to the transparent portion 10, so that the transparency of the transparent portion 10 is not degraded.

Alternatively, the peripheral portion 12 may be divided into two or more sections by printing or overlapped-printing two or more different paints on predetermined positions as shown in FIG. 1.

As shown in FIG. 1, a FIG. 16 including characters may be formed in the recess 14. The FIG. 16 may be transparent by removing the paints 18 coated on a desired location in a predetermined shape. Alternatively, the FIG. 16 may have a color different from that of the peripheral portion 12 by printing or depositing a different kind of paints in a predetermined shape with or without the paints 18 being removed, if the FIG. 16 is formed at the location in which the recess 14 is formed as described above, a more beautiful appearance than when the figure is formed at a flat portion can be obtained.

Meanwhile, the recess 14 may have a curved shape as shown in FIG. 2. Furthermore, the recess 14 may have a very smooth surface and reflective paints may be used as the paints 18. In this case, the recess 14 may look convex visually due to an optical effect. Therefore, the window 1 can have a more elegant appearance compared with when a simple recess is formed.

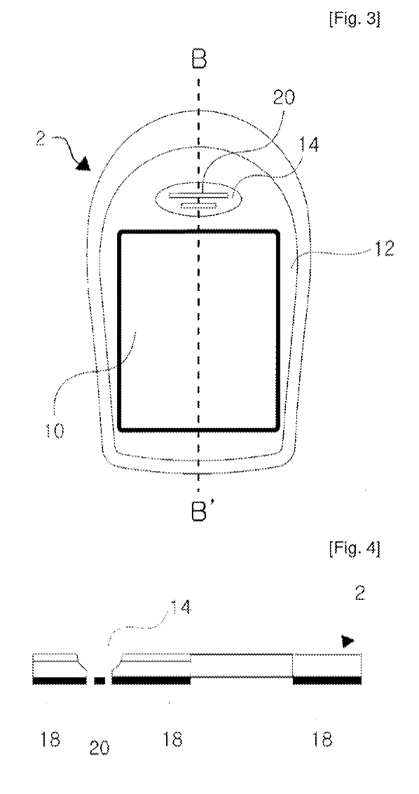

FIG. 3 is a top view of a window according to another embodiment of the present Invention. In the window shown in FIG. 3, the same reference numerals will be used to refer to the same pans as those of the window shown in FIG. 1 and detailed description thereof will not be provided. The window 2 of the present embodiment includes a transparent portion 10 and a peripheral portion 12. A recess 14 may be formed in the peripheral portion 12.

FIG. 4 is across-sectional view of the window taken along line B-B′ in FIG. 3. Paints 18 are printed or deposited on locations corresponding to the peripheral portion 12 of the window 2, thus making the peripheral portion 12 opaque, whereas the paints 18 are not printed or deposited on locations corresponding to the transparent portion 10. Therefore, other materials than the material of the window 2 itself are not added to the transparent portion 10, so that the transparency of the transparent portion 10 is not degraded.

Meanwhile, the recess 14 may be formed at a location corresponding to a location in which the speaker of the mobile phone is installed. Furthermore, through-holes 20 are formed in the recess 14, so that voice outputs of the speaker can be transferred to a user more easily. In this case, the display unit and the speaker installation portion can be assembled with them being covered by coupling only the window 2 without the need to couple an additional component to the speaker installation portion when, fabricating the mobile phone. Therefore, the number of components and the number of processes, which are required to fabricate the mobile phone, can be reduced, the production cost can be saved, and efficiency can be improved. Furthermore, a user can visually easily know a location in which the speaker is installed since the recess 14 is formed. This can increase user's convenience.

Meanwhile, the recess 14 may have a curved shape as shown in FIG. 2. Furthermore, the recess 14 may have a very smooth surface and reflective paints may be used as the paints 18. In this case, the recess 14 may look convex visually due to an optical effect. Therefore, the window 2 can have a more elegant appearance compared with when a simple recess is formed.

The present embodiments have beet) described above in connection with the recess 14, the FIG. 16, and the through-hole 20 having a specific shape. However, the shape of the recess 14 may be modified, if needed, and the recess 14 may be in plural numbers depending on a designer's need. For example, a recess having a pre-determined character or figure shape may be formed in the window. When the peripheral portion 12 is partitioned as shown in FIG. 1, the boundary line may be recessed.

Furthermore, the recess 14 may have a variety of cross sections, such as triangle or cone. These modifications will be evident to those having ordinary skill in the art and fall within the scope of the present invention.

A method of producing a window according to the present invention will be described below.

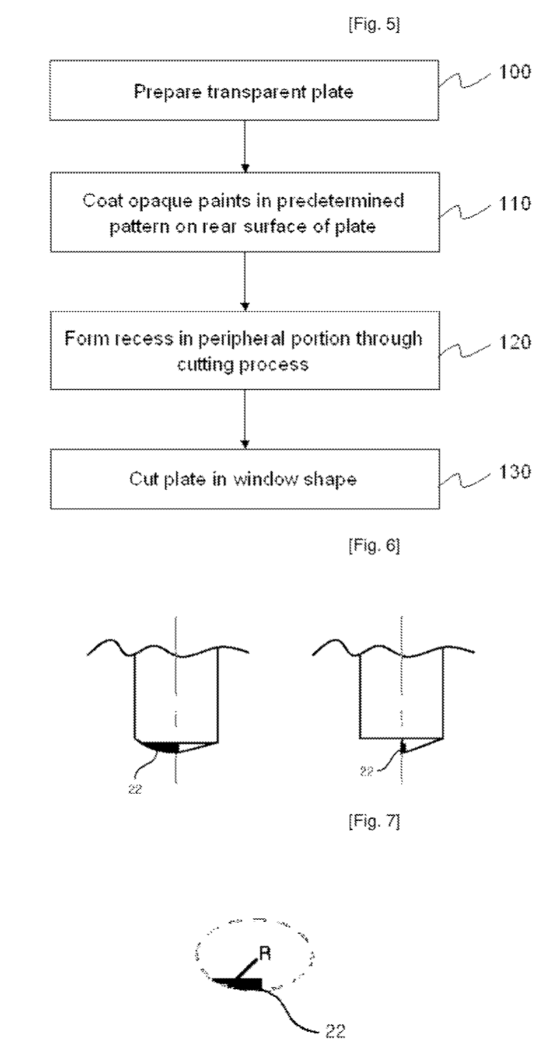

FIG. 5 is a flowchart illustrating a method of producing a window according to a first embodiment of the present invention, in the producing method of the present embodiment, a plate made of a transparent material, such as acrylic or special glass, is first prepared (step 100). In step 110, paints are then coated on a rear surface of the plate in a predetermined pattern, thus forming an opaque peripheral portion 12 (FIG. 1). The transparent portion 10 (FIG. 1) is not coated with the paints in order for the transparent portion 10 to maintain its transparency. The paints may include metal or metal oxide, such as nickel (Ni), aluminum (Al), silicon dioxide (SiO₂), titanium dioxide (TiO₂), chrome (Cr), and copper (Cu). Furthermore, the paints may be coated by printing such as silk-screen or deposition.

In step 120, the plate is cut to form the recess 14 (FIG. 1). The recess 14 may have a curved shape and the cutting process may be performed with a bite having a circular tip.

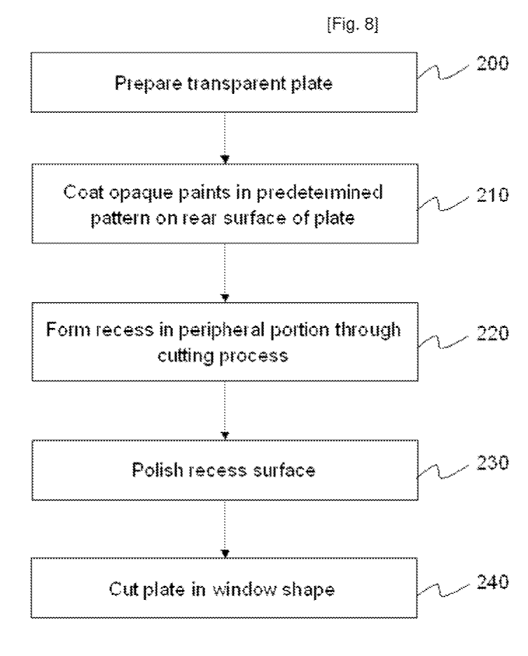

FIG. 6 is front and lateral views of a bite used in the cutting process according to the embodiment of FIG. 5. FIG. 7 is an exaggerated view of the bite tip of the bite shown in FIG. 6. The bite is of tip bite type and has a circular tip 22. In general, the roughness of the cut surface is in inverse proportion to the nose radius R of the bite. Therefore, since the bite having the circular tip 22 not a straight tip is used, the cut surface can become smoother and can minimize cutting traces. Furthermore, the nose radius R can be increased, in order to obtain a better cut surface. The bite tip 22 may be made of natural diamond. In this case, a more accurate and smoother cut surface can be obtained. Therefore, an external appearance of the window can become elegant, not only by forming the recess 14, but also by having the recess have a curved shape and a smooth surface, which can look convex visually in cooperation with reflective, paints. Furthermore, by forming both the recess 14 that has the smooth, curved surface and may be seen as a convex portion and a conventional recess, a visual effect can be increased.

The present embodiment has been described above in connection with the tip bite. However, the present invention is not limited thereto. Those skilled in the art will appreciate that a variety of bites can be used if a circular bite blade is used.

Finally, in step 130, the plate is cut according to a desired window shape, thus completing the fabrication of the window.

FIG. 8 is a flowchart illustrating a method of producing a window according to a second embodiment of the present invention. The producing method of the present embodiment is the same as that of the first embodiment except for a recess cutting step and a polishing step. Therefore, the same steps will not be described in detail. In the producing method of the present embodiment, a transparent plate is first prepared (step 200). Paints are coated on a rear surface of the plate to form an opaque peripheral portion (step 210).

Thereafter, a cutting process is performed on the plate to form the recess 14 (FIG. 1) (step 220). At this time, the recess 14 may have a curved surface, and the cutting process may be performed using a circular bite as shown in FIG. 6.

Next, in step 230, polishing is performed on the processed recess 14. In the present embodiment, by adding the polishing step as described above, a window having a smooth cut surface can be obtained even if the cut surface was relatively roughly processed. Therefore, the cutting process of the step 220 can be performed relatively roughly. Due to this, not only natural diamond but also artificial diamond can be used as the material of the bite tip 22, thereby saving the cost. Furthermore, cutting can be performed within a short period of time compared with the embodiment, of FIG. 5. Accordingly, the cutting cost and time can be reduced compared with the previous embodiment.

After the recess 14 is processed relatively roughly as described above, the polishing step (step 230) may be performed. Therefore, the recess 14 having a smooth surface can be obtained in the same manner as the previous embodiment. In addition, if the recess 14 has a curved surface, a visual effect in which the recess looks convex due to a combined effect of the reflective paints and the recess can be obtained.

In step 240, the plate is cut in the shape of a desired, window, thereby completing the fabrication of the window.

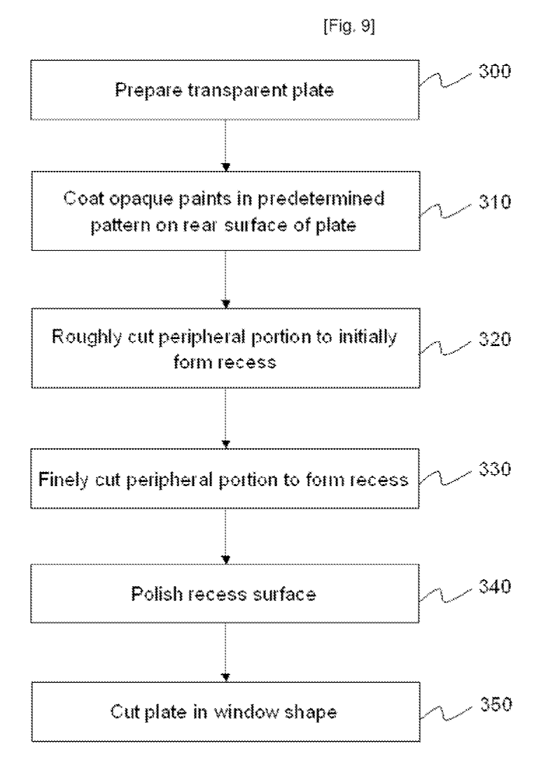

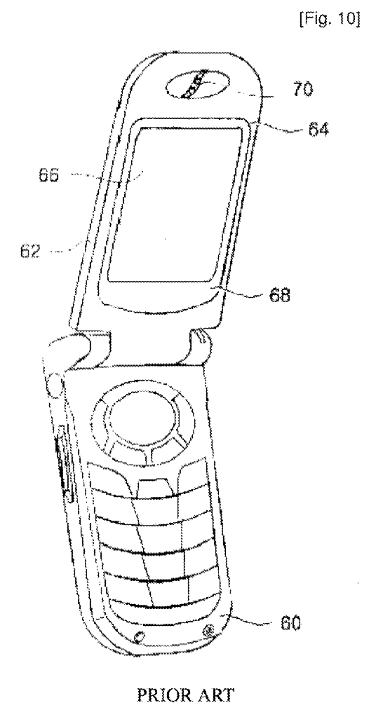

FIG. 9 is a flowchart illustrating a method of producing a window according to a third embodiment of the present invention. The producing method, of the present embodiment is the same as that of the first embodiment except for a recess formation step and a polishing step. Therefore, the same steps will not be described in detail. In the producing method of the present embodiment, a transparent plate is first prepared (step 300), and paints are coated on a rear surface of the plate, thus forming an opaque peripheral portion (step 310).

In step 320, a predetermined position of the peripheral portion 12 of the plate is cut using a roughing mill, thus initially forming the recess 14 (FIG. 1). In this step, since the recess 14 may be processed relatively roughly, either natural diamond or artificial diamond may be used as the material of the bite tip 22.

In step 330, the recess is cut using an end mill, thus obtaining the recess 14 having a smooth cut surface. In this step, during the cutting process, a direction in which the bite is rotated and/or conveyed (if the bite is conveyed upon cutting) may be opposite to that of the bite in step 320. Therefore, cutting traces remaining on the cut surface in step 320 are removed in step 330 and the cut surface can become smooth accordingly. Natural diamond may be used as the bite tip 22 in step 330.

The surface of the recess 14 processed in step 340 is polished to obtain a smooth surface. In the present embodiment, since the 2-step cutting processes of step 320 and step 330 are performed, a time taken to perform the polishing process can be reduced and the cost can be saved in comparison with the second embodiment.

The plate is then cut in a desired window shape, thus completing the fabrication of the window (step 350).

The producing method of the window in which the recess 14 is formed has been described above. However, a step of forming the FIG. 16 (FIG. 1) and/or the through-hole 20 (FIG. 1) may be added to the method.

For example, in the above embodiments, after the steps 110, 210, and 310 of coating the paints, the step of forming the FIG. 16 may be added. The step of forming the figure may include the steps of removing paints in a predetermined shape, removing the paints in a predetermined shape and then, coating another paints, or additionally coating another painting in a predetermined shape. Furthermore, the step of forming the figure may be added after the recess formation steps 120, 220, and 330 or the polishing steps 230 and 340.

Alternatively, in the above embodiments, after the recess formation steps 120, 220, and 330, the step of forming the through-hole 20 may be added. The step of forming the through-hole may include the step of forming a through-hole having a pre-determined shape through drilling or forming a through-hole having a predetermined shape through cutting. In addition, the through-hole formation step may be added after the paints coating steps 110, 210, and 310.

Furthermore, the process sequence described in connection with the embodiments is only illustrative. Those skilled in the art can easily modify the sequence, it is evident that such modification also falls within the scope of the present invention.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope, of the appended claims.

1. A method of producing a window for protecting a display of a mobile phone, the method comprising:
preparing a transparent plate;
forming a recess at a predetermined position of the plate through a cutting process; and
cutting the plate in the shape of the window.

2. The method as defined in claim 1, wherein the cutting process in the forming is performed using a bite with a circular bite tip.

3. The method as defined in claim 1, wherein the cutting process in the forming is performed using a bite with a bite tip made of natural diamond.

4. A method of producing a window for protecting a display of a mobile phone, the method comprising:
preparing a transparent plate;
forming a recess at a predetermined position of the plate through a cutting process;
polishing the surface of the recess; and
cutting the plate in the shape of the window.

5. The method as defined in claim 4, wherein the cutting process in the forming is performed using a bite with a circular bite tip.

6. A method of producing a window for protecting a display of a mobile phone, fee method comprising:
preparing a transparent plate;
forming initially a recess at a predetermined position of the plate through a first cutting process;
forming finally fee recess at a predetermined position of the plate through a second cutting process;
polishing the surface of the recess; and
cutting the plate in the shape of the window.

7. The method as defined in claim 6, wherein the second cutting process is performed using a bite with a circular bite tip.

8. The method as defined in claim 6, wherein the second cutting process is performed using a bite with a bite tip made of natural diamond.

9. The method as defined in claim 6, wherein in the second cutting process, a bite rotates and/or is conveyed in an opposite direction to a direction in which a bite rotates and/or is conveyed in the first cutting process.

10. A window for protecting a display of a mobile phone, comprising:
a transparent portion for allowing a user to view displayed content of the display; and
a peripheral portion for prohibiting the user from viewing portions other than the displayed content,
wherein a recess having a smooth surface is formed in the peripheral portion.

11. The window as defined in claim 10, wherein the recess is formed at a location corresponding to a location at which a speaker of the mobile phone is installed, and a through-hole is formed in the recess.
